(19) United States
(12) Patent Application Publication
(10) Pub. No.: US 2004/0130121 A1
(43) Pub. Date: Jul. 8, 2004

(54) Ox horn shape bicycle handle capable of being combined with another handle

(76) Inventor: Chun-Feng Chen, Taichung (TW)

Correspondence Address: Chun-Feng Chen, 235 Chung - Ho, Box 8-24, Taipei, TW

(21) Appl. No.: 10/679,777

(22) Filed: Oct. 2, 2003

(30) Foreign Application Priority Data
Oct. 3, 2002 (TW) 091215971

(51) Int. Cl. B62K 1/00

(52) U.S. Cl. 280/274

(57) ABSTRACT

An ox horn shape bicycle handle is capable of being combined with another handle. The ox horn shape bicycle handle comprises two rear retaining seats; and two front retaining seats; each front retaining seat being positioned in front of the rear retaining seat. One side of the front retaining seat being combined to the positioning groove of the rear retaining seat. The front retaining seat has a plurality of second positioning threaded holes at positions corresponding to first positioning threaded holes. Thereby, the front retaining seat and the rear retaining seat are engaged by using studs to engage the first positioning threaded holes and the second threaded holes. A bottom end of the front retaining seat has a retaining seat. The retaining seat has a through hole. One side of the front retaining seat has a third threaded hole. Thereby, the second holding portion is locked to the retaining seat.

### FIELD OF THE INVENTION

The present invention relates to bicycle handles, and particularly to an ox horn shape bicycle handle capable of being combined with another handle.

### BACKGROUND OF THE INVENTION

In the prior art, the bicycle handle is made of a round tube with two ends of the tube being bent to be as two holding portions.

To have a preferred holding feeling, as shown in FIG. 1, a prior art bicycle handle is illustrated. The ox horn shape bicycle handle 2 has two ends. Each end has a first holding portion 21 which is a round tube. The two first holding portions 21 are connected with respective elliptical cross section portions 22. The two elliptical cross section portions 22 are connected through a middle section 20.

In another prior art bicycle handle, as shown in FIG. 2, a handle 3 has two holding portions 31 placed at a front end. Moreover, a rear end of each second holding portion 31 is installed with a protecting cushion 32 which are vertically bent from the second holding portion 31. Thereby, the elbow of the user can place on the protection cushion 32.

The two prior arts have their disadvantages. However, there is no prior art which can combine the two kinds of handles so as to have the advantages of the two handles.

### SUMMARY OF THE INVENTION

Accordingly, the object of the present invention is to provide an ox horn shape bicycle handle is capable of being combined with another handle. The ox horn shape bicycle handle comprises two rear retaining seats; and two front retaining seats; each front retaining seat being positioned in front of the rear retaining seat. One side of the front retaining seat being combined to the positioning groove of the rear retaining seat. The front retaining seat has a plurality of second positioning threaded holes at positions corresponding to first positioning threaded holes. Thereby, the front retaining seat and the rear retaining seat are engaged by using studs to engage the first positioning threaded holes and the second threaded holes. A bottom end of the front retaining seat has a retaining seat. The retaining seat has a through hole. One side of the front retaining seat has a third threaded hole. Thereby, the second holding portion is locked to the retaining seat.

The various objects and advantages of the present invention will be more readily understood from the following detailed description when read in conjunction with the appended drawing.

### BRIEF DESCRIPTION OF THE DRAWINGS

FIG. 1 is a schematic view showing the handle of the prior art ox horn shape bicycle handle.

FIG. 2 is a schematic perspective view of the second handle of the present invention.

FIG. 3 is an elevational schematic perspective view of the present invention.

FIG. 3A is a front assembled schematic view of the present invention.

FIG. 3B is a rear assembled schematic view of the present invention.

FIG. 3C is a lateral schematic cross view of the present invention.

FIG. 3D is a lateral enlarged schematic cross view of the present invention.

### DETAILED DESCRIPTION OF THE PREFERRED EMBODIMENTS

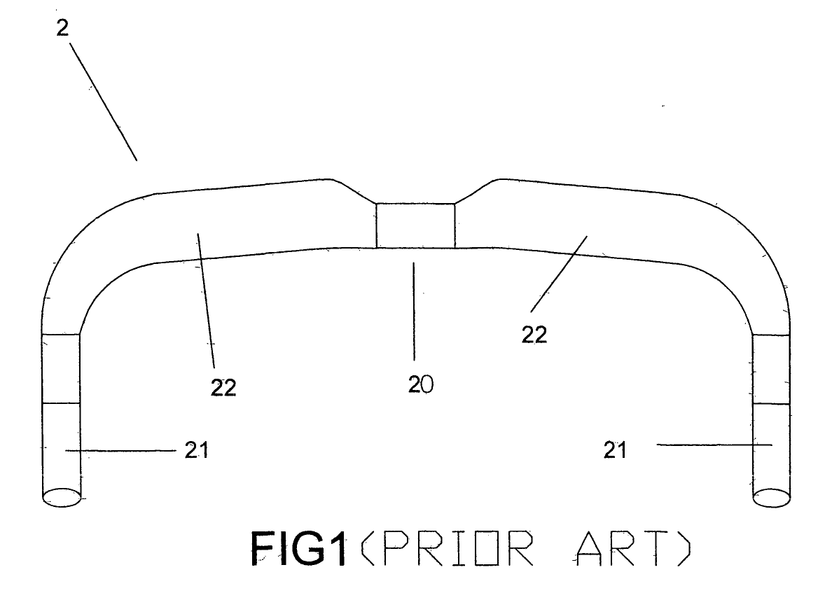

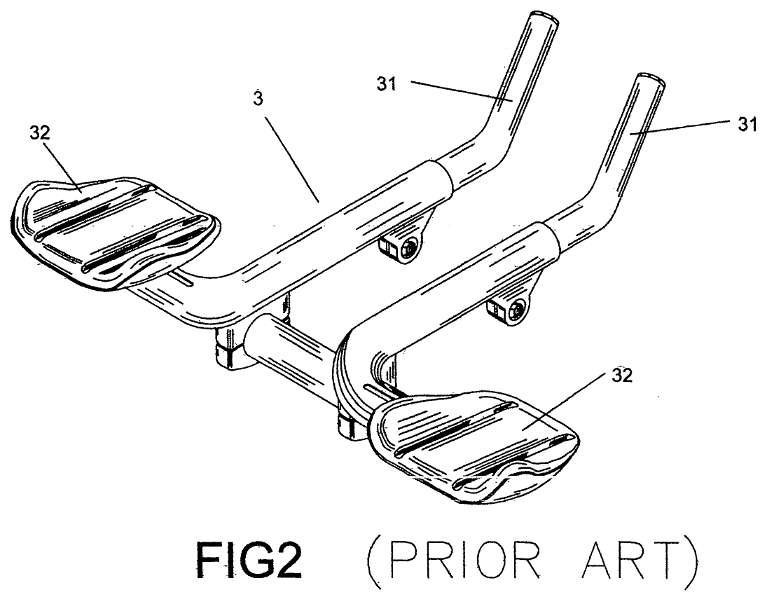

With reference to FIGS. 1, 2, 3, 3A, 3B, 3C, and 3D, in the ox horn shape bicycle handle of the present invention, the ox horn shape bicycle handle 2 has two ends. Each end has a first holding portion 21 which is a round tube. The two first holding portions 21 are connected with respective elliptical cross section portions 22. The two elliptical cross section portions 22 are connected through a middle section 20. In the present invention, a second handle 3 can be assembled to the ox horn shape bicycle handle 2 with the two second holding portions 31 are placed at a front end. Moreover, a rear end of each second holding portion 31 is installed with a protecting cushion 32 which are vertically bended from the second holding portion 31. Thereby, the elbow of the user can place on the protection cushion 32. In the present invention the ox horn shape bicycle handle has two rear retaining seats 4 and two front retaining seats 5.

Each rear retaining seat 4 includes a positioning groove 41 capable of being engaged to the elliptical cross section portion 22. A top of the rear retaining seat 4 has a connecting seat 42 for connecting the second handle 3 (the connection of the connecting seat 42 and the second handle 3 is known in the prior art, and thus the detail will not be described here). A front end of the rear retaining seat 4 has a plurality of first positioning threaded holes 43.

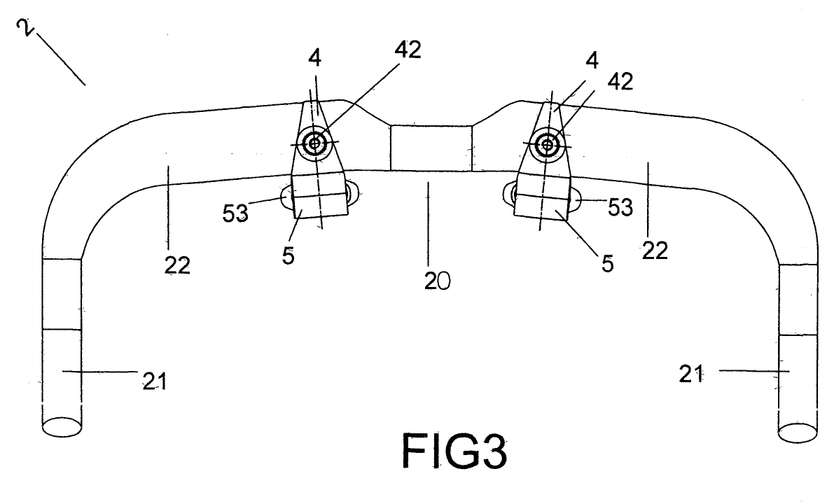

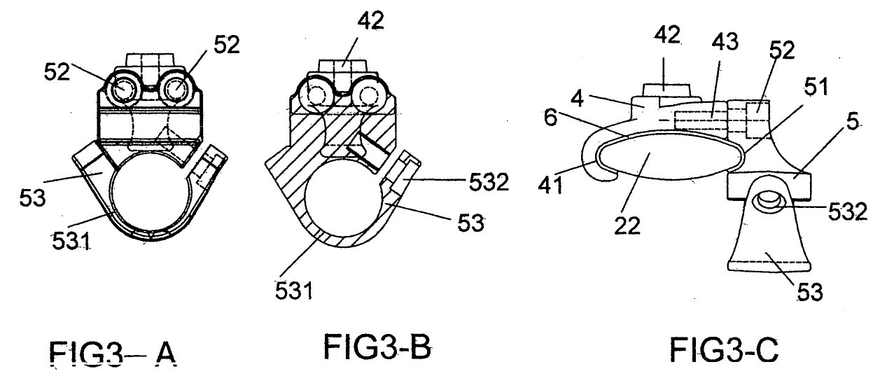

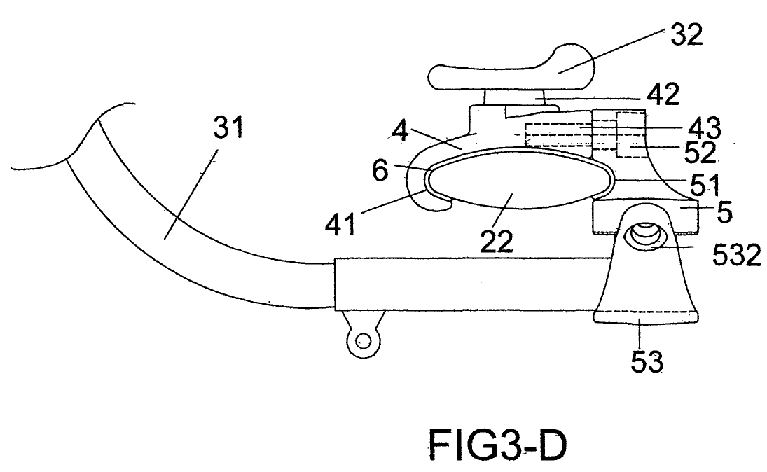

The front retaining seat 5 is positioned in front of the rear retaining seat 4. A side of the front retaining seat 5 is combined to the positioning groove 41 of the rear retaining seat 4 has a cambered groove 51. The cambered groove 51 and the positioning groove 41 are formed as an elliptical cross section so as to engage with the elliptical cross section portion 22 of the ox horn shape bicycle handle 2. The front retaining seat 5 has a plurality of second positioning threaded holes 52 at positions corresponding to first positioning threaded holes 43. Thereby, the front retaining seat 5 and the rear retaining seat 4 can be engaged by using studs to engage the first positioning threaded holes 43 and the second threaded holes 52 (referring to FIGS. 3C and 3D). A bottom end of the front retaining seat 5 has a retaining seat 53. The retaining seat 53 has a through hole 531. One side of the front retaining seat 5 has a third threaded hole 532. Thereby, the second holding portion 31 can be locked to the retaining seat 53 by using a stud to pass through the through hole 531 (referring to FIGS. 3A and 3B).

By above mentioned structure, not only the ox horn shape bicycle handle 2 is used, but also the second handle 3 can be added to the first handle 2 so that the ox horn shape bicycle handle is addled with the second handle. Thus, two handles are added to the ox horn shape bicycle handle.

Referring to FIGS. 3B and 3D, it is shown that a position pad 6 is added to the wall of the elliptical section formed by the cambered groove 51 and the positioning groove 41 so that the rear retaining seat 4 and front retaining seat 5 are firmly secured to the elliptical cross section portion 22.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An ox horn shape bicycle handle capable of being combined with another handle; the ox horn shape bicycle handle having two ends; each end having a first holding portion which is a round tube; the two first holding portions being connected with respective elliptical cross section portions; the two elliptical cross section portions being connected through a middle section, a second handle being assembled to the ox horn shape bicycle handle; the two second holding portions, being placed at a front end of the second handle; a rear end of each second holding portion being installed with a protecting cushion which are vertically bended from the second holding portion; thereby, the elbow of the user can place on the protection cushion;
the ox horn shape bicycle handle comprising
two rear retaining seats; each rear retaining seat including a positioning groove capable of being engaged to the elliptical cross section portion; a top of the rear retaining seat having a connecting seat for connecting the second handle; a front end of the rear retaining seat having a plurality of first positioning threaded holes;
two front retaining seats; each front retaining seat being positioned in front of the rear retaining seat; one side of the front retaining seat being combined to the positioning groove of the rear retaining seat; the side of the front retaining seat having a cambered groove; the cambered groove and the positioning groove being formed as an elliptical cross section so as to engage with the elliptical cross section portion of the ox horn shape bicycle handle; the front retaining seat having a plurality of second positioning threaded holes at positions corresponding to first positioning threaded holes; thereby, the front retaining seat and the rear retaining seat are engaged by using studs to engage the first positioning threaded holes; and the second threaded holes; a bottom end of the front retaining seat having a retaining seat; the retaining seat having a through hole; one side of the front retaining seat having a third threaded hole; thereby, the second holding portion being locked to the retaining seat by using a stud to pass through the through hole;
wherein by above mentioned structure, not only the ox horn shape bicycle handle is used, but also the second handle is added to the first handle so that the ox horn shape bicycle handle is added with the second handle.

2. The ox horn shape bicycle handle capable of being combined with another handle as claimed in claim 1, wherein a position pad is added to the wall of the elliptical section formed by the cambered groove and the positioning groove so that the rear retaining seat and front retaining seat are firmly secured to the elliptical cross section portion.
